(19) United States
(12) Patent Application Publication
(10) Pub. No.: US 2015/0058811 A1
(43) Pub. Date: Feb. 26, 2015

(54) CONTROL SYSTEM FOR DISPLAY SCREEN, INPUT APPARATUS AND CONTROL METHOD

(71) Applicant: UTECHZONE CO., LTD., New Taipei City (TW)

(72) Inventors: Chia-Chun Tsou, New Taipei City (TW); Chieh-Yu Lin, New Taipei City (TW); Yi-Wen Chen, New Taipei City (TW)

(73) Assignee: UTECHZONE CO., LTD., New Taipei City (TW)

(21) Appl. No.: 14/154,190

(22) Filed: Jan. 14, 2014

(30) Foreign Application Priority Data
Aug. 20, 2013 (TW) 102129870

(51) Int. Cl. G06F 3/0488

(52) U.S. Cl. CPC G06F 3/0488
USPC 715/863

(57) ABSTRACT

A control system for a display screen, an input apparatus and a control method are provided. An image capturing unit is used to continuously capture an image toward a first side of a display apparatus, and a processing unit is used to execute an image analyzing process for the captured image. The image analyzing process includes the following steps. Whether an object enters an initial sensing space located at the first side is detected. A virtual operating plane is established according to a location of the object when the object enters the initial sensing space is detected, wherein a size of the virtual operating plane is proportioned to a size of the display screen. A movement information of the object in the virtual operating plane is detected for controlling content of the display screen through the movement information.

### CROSS-REFERENCE TO RELATED APPLICATION

This application claims the priority benefit of Taiwan application serial no. 102129870, filed Aug. 20, 2013. The entirety of the above-mentioned patent application is hereby incorporated by reference herein and made a part of this specification.

### BACKGROUND OF THE INVENTION

1. Field of the Invention

The present invention relates to a control mechanism for a display screen, and more particularly, to a control system, an input apparatus and a control method capable of operating a display screen in a three-dimensional space.

2. Description of the Related Art

Most of the traditional electronic products are only equipped with an input apparatus, such as a remote control, a keyboard, and a mouse, for a user to use and perform operation. While, as technology advances, more and more researches are committed to the development and improvement of operator interfaces. New generation of the operator interfaces has become more humane and more convenient. In recent years, traditional input apparatuses of the electronic products are gradually being replaced by other input apparatuses, wherein the most popular replacement of the traditional input apparatuses is to use gestures.

Gesture operation has been widely applied in a variety of human-computer interaction (HCI) interfaces, such as robot remote control, electrical remote control, slide presentations operation, and so forth. The user can directly control a user interface in a three-dimensional space without having to touch the input apparatus, such as the keyboard, the mouse and the remote control, by using the gesture, and can drive the electronics products with intuitive action. As such, enabling a method for controlling the display screen in the three-dimensional space to be easier and in compliance with diversified usage scenarios has become an important part of current development.

For instance, US Patent No. 20120223882 discloses a cursor control method for a three-dimensional user interface that captures an image of the user, and identifies a gesture of the user, so that the user can control and operate a computer using the gesture. The US Patent No. 20120223882 discloses the following techniques: detecting locations of the user's wrist, elbow and shoulder, taking these locations as references points for the gesture, and converting coordinates of the user gesture location to cursor coordinates in the image. In addition, the US Patent No. 20120223882 also discloses a filter function for erroneous operation of the gesture and a gesture automatic correction technique.

Moreover, U.S. Pat. No. 8,194,038 discloses a multi-directional remote control system and a cursor speed control method that provide an image recognition technique capable of being applied to TV set-top boxes, multimedia systems, web browsers, and so forth. The remote control system disclosed by the U.S. Pat. No. 8,194,038 has a light emitting diode (LED) thereon, and a camera is installed on a screen thereof, such that the location of the LED is being determined after an imaging capturing, and a pixel size of the LED is being detected and used as a background removal process for confirming the location of LED in the space. And, the U.S. Pat. No. 8,194,038 further discloses a formula for enhancing a numerical accuracy of X and Y coordinates of the location.

### SUMMARY OF THE INVENTION

The invention provides a control system for a display screen, an input apparatus and a control method that are capable of controlling contents of the display screen in a three-dimensional space via image analysis.

The control method of the display screen of the invention includes: continuously capturing an image toward a first side faced by a display screen of a display apparatus through an image capturing unit, and executing an image analyzing process for the image captured by the image capturing unit via a processing unit. The image analyzing process includes: detecting whether an object has entered an initial sensing space, wherein the initial sensing space is located at the first side, and the initial sensing space is located within an image capturing range of the image capturing unit; establishing a virtual operating plane according to a location of the object when the object enters the initial sensing space is detected, wherein a size of the virtual operating plane is proportioned to a size of the display screen; and detecting a movement information of the object in the virtual operating plane for controlling content of the display screen through the movement information.

In an embodiment of the invention, when the object enters the initial sensing space is detected and before the virtual operating plane is established, it is to determine whether the object is to obtain a control of the display screen. The step of determining whether the object is to obtain a control of the display screen includes: obtaining a feature block based on the object entered the initial sensing space; determining whether an area of the feature block is greater than a preset area; and if the area of the feature block is greater than the preset area, then determining that the object is to obtain the control of the display screen.

In an embodiment of the invention, the step of establishing the virtual operating plane according to the location of the object includes: using a boundary position of the feature block as a reference, and using a specified range to determine a centroid calculation block of the object; calculating a centroid of the centroid calculation block; and establishing the virtual operating plane by using the centroid as a center point, and by being proportional to the size of the display screen.

In an embodiment of the invention, after the movement information of the object in the virtual operating plane is detected, the movement information is sent to a calculation device of the display apparatus, and a virtual coordinate of the centroid in the virtual operating plane is transformed into a display coordinate corresponded to the display screen through the calculating device.

In an embodiment of the invention, after the movement information of the object in the virtual operating plane is detected, the virtual coordinate of the centroid in the virtual operating plane is transformed into the display coordinate corresponded to the display screen.

In an embodiment of the invention, the step of determining whether the object is to obtain the control of the display screen further including: calculating distances from the object and from another object to the display screen, respectively, when the another object simultaneously enters the initial sensing space is detected and when an area of the feature block of the another object is also greater than the area of the preset area, so that the one being closest to the display screen in distance is determined to obtain the control of the display screen.

In an embodiment of the invention, after the virtual operating plane is established, a cursor of the display screen may be moved to a center of the display screen.

In an embodiment of the invention, after the virtual operating plane is established, when the object leaves the virtual operating plane over a preset time, the control of the object may further be releases in order to remove a setting of the virtual operating plane.

In an embodiment of the invention, the aforementioned method further includes defining the initial sensing space according to a calibration information of the image capturing unit, and executing a background removal to the initial sensing space.

An input apparatus of the invention includes an image capturing unit, a processing unit and a transmission unit. The image capturing unit is configured to continuously capture an image toward a first side faced by a display screen of a display apparatus. The processing unit is coupled to the image capturing unit. The processing unit detects whether an object has entered an initial sensing space by analyzing the image captured by the image capturing unit. In addition, when the object enters the initial sensing space is detected, the processing unit establishes a virtual operating plane according to a location of the object so as to detect a movement information of the object in the virtual operating plane, wherein the initial sensing space is located at the first side, the initial sensing space is located within an image capturing range of the image capturing unit, a size of the virtual operating plane is proportioned to a size of the display screen, and the virtual operating plane is parallel to the display screen. The transmission unit is coupled to the processing unit. The transmission unit transmits the movement information to a calculating device corresponded by the display apparatus for controlling content of the display screen.

A control system for a display screen of the invention includes a display apparatus, a calculating device and an input apparatus. The display apparatus is configured to display a display screen. The calculating device is coupled to the display apparatus for controlling contents of the display screen. The input apparatus is coupled to the calculating device and includes an image capturing unit, a processing unit and a transmission unit. The image capturing unit is configured to continuously capture an image toward a first side faced by a display screen of a display apparatus. The processing unit is coupled to the image capturing unit. The processing unit detects whether an object has entered an initial sensing space by analyzing the image captured by the image capturing unit. In addition, when the object enters the initial sensing space is detected, the processing unit establishes a virtual operating plane according to a location of the object so as to detect a movement information of the object in the virtual operating plane, wherein the initial sensing space is located at the first side, the initial sensing space is located within an image capturing range of the image capturing unit, a size of the virtual operating plane is proportioned to a size of the display screen, and the virtual operating plane is parallel to the display screen. The transmission unit is coupled to the processing unit and transmits the movement information to the calculating device, so that the calculating device controls contents of the display screen according to the movement information.

A control system for a display screen of the invention includes: a display apparatus, an image capturing unit and a calculating device. The display apparatus is configured to display a display screen. The image capturing unit is configured to continuously capture an image toward a first side faced by a display screen. The calculating device is coupled to the image capturing unit and the display apparatus, and detects whether an object has entered an initial sensing space by analyzing the image captured by the image capturing unit, and establishes a virtual operating plane according to a location of the object when the object enters the initial sensing space is detected, so as to detect a movement information of the object in the virtual operating plane for controlling contents of the display screen through the movement information.

In view of the foregoing, the invention, after using the initial sensing space to determine that the object is to obtain the control, further establishes the virtual operating plane according to the location of the object. As such, any user may use any object to control the contents of the display screen in the three-dimensional space, thereby enhancing the convenience of use.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a control system for a display screen according to an embodiment of the invention.

FIG. 2 is a configuration diagram illustrating an input apparatus according to an embodiment of the invention.

FIG. 3 is a flow diagram illustrating a control method of a display screen according to an embodiment of the invention.

FIG. 4 is a schematic perspective diagram illustrating a control method of a display screen according to an embodiment of the invention.

FIG. 5A and FIG. 5B are schematic diagrams illustrating an establishment of a virtual operating plane according to an embodiment of the invention.

FIG. 6 is a flow diagram illustrating a control method of a display screen according to another embodiment of the invention.

FIG. 7 a schematic perspective diagram illustrating a control method of a display screen according to another embodiment of the invention.

FIG. 8 is a block diagram illustrating a control system for a display screen according to another embodiment of the invention.

### DESCRIPTION OF THE PREFERRED EMBODIMENTS

The invention provides a control system from a display screen, an input apparatus and a control method that use an image capturing unit to capture an image, and use a processing unit to perform an image analyzing process to the captured image for controlling contents of the display screen based on the analysis results.

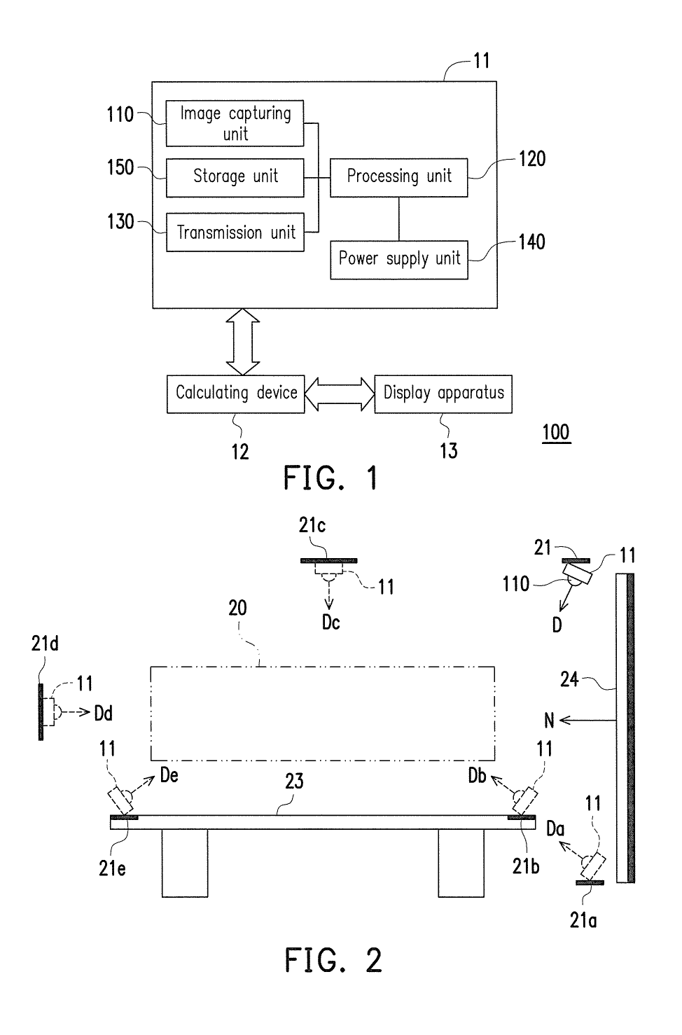

FIG. 1 is a block diagram illustrating a control system for a display screen according to an embodiment of the invention. Referring to FIG. 1, a control system 100 includes an input apparatus 11, a calculating device 12 and a display apparatus 13. Herein, the calculating device 12 may use wired or wireless means to perform data transmission to communicate with the input apparatus 11 and the display apparatus 13. In the present embodiment, the calculating device 12 may control a display screen of the display apparatus 13 through the input apparatus 11. Detail descriptions regarding each component are provided as follows.

The calculating device 12, for example, is a host having computing capacity, such as a desktop computer, a laptop computer, a tablet PC, which uses wired or wireless means to couple to the display apparatus 13, so as to display the desired contents through the display apparatus 13, and the calculating device 12 has an ability of controlling the display contents.

The display apparatus 13 may be any type of display, such as a flat display, a projection display or a soft display. If the display apparatus 13 is the flat display or the soft display such as a liquid crystal display (LCD) or a light emitting diode (LED), then the display screen is a display area on the display. If the display apparatus 13 is the projection display, then the display screen, for example, is a projection screen.

The input apparatus 11 includes an image capturing unit 110, a processing unit 120, a transmission unit 130, a power supply unit 140 and a storage unit 150. In the present embodiment, the input apparatus 11 is not disposed within the calculating device 12, but is an independent calculating device that provides power through the power supply unit 140, so as to drive the image capturing unit 110 to continuously capture an image, and so that the processing unit 120 can perform an image analyzing process on the captured image. The processing unit 120 is coupled to the image capturing unit 110, the transmission unit 130, the power supply unit 140 and the storage unit 150.

The image capturing unit 110, for example, is a depth camera, a stereo camera, or any camera having a charge coupled device (CCD) lens, a complementary metal oxide semiconductor transistors (CMOS) lens, or an infrared lens. The image capturing unit 110 is configured to continuously capture the image toward a first side faced by the display screen of the display apparatus 13. For instance, the image capturing unit 110 is configured to face toward the front of the display screen. The facing direction (an image capturing direction) of the image capturing unit 110 varies as the configuration of the image capturing unit 110 changes, and the image capturing direction may be parallel to a normal direction of the display screen, or the image capturing direction may be perpendicular to the normal direction of the display screen, or a angle between the image capturing direction and the normal direction of the display screen falls within an angle range (such as 45 degrees to 135 degrees). The following below provides an example for describing the configuration of the input apparatus 11.

FIG. 2 is a configuration diagram illustrating an input apparatus according to an embodiment of the invention. Referring to FIG. 1 and FIG. 2 at the same time, in the present embodiment, the input apparatus 11 being disposed at a location 21 is taken as an example for the description. Moreover, the input apparatus 11 may also be disposed at other location, such as any one of locations 21a to 21e, as long as the image capturing unit 110 is configured as facing towards the front of the display screen 24. The input apparatus 11 illustrated with dashed-lines in FIG. 2 is provided to demonstrate that the input apparatus 11 may also be disposed at a different location, and the input apparatus 11 is not simultaneously disposed at the locations 21, 21a to 21e.

In terms of the input apparatus 11 disposed at the location 21, the image capturing unit 110 thereof captures the image toward the first side faced by the display screen 24 of the display apparatus 13. The image capturing direction D of the lens of the image capturing unit 110 faces toward the front of the display screen 24, so as to capture the image. In the present embodiment, an angle between the image capturing direction D and a normal direction N of the display screen 24 is within the angle range (such as 45 degrees to 135 degrees).

Moreover, in terms of the input apparatus 11 at the location 21c, wherein an image capturing direction Dc is perpendicular to the normal direction N of the display screen 24. In terms of the input apparatus 11 at the location 21d, an image capturing direction Dd thereof is parallel to the normal direction N of the display screen 24. Angles between the image capturing direction Da, the image capturing direction Db and the image capturing direction De of each respective input apparatus 11 at the location 21a, the location 21b and the location 21e and the normal direction N of the display screen 24 are within the angle range of 45 degrees to 135 degrees. However, it can be known that the location 21 and the locations 21a to 21e, namely each image capturing direction, are only provided as an example for the purpose of descriptions, and the invention is not limited thereto, as long as the image capturing unit 110 may capture the image toward the first side (front of the display screen 24) faced by the display screen 24.

The processing unit 120, for example, is a central processing unit (CPU), or other programmable general use or specific use Microprocessor, digital signal processor (DSP), programmable controller, application specific integrated circuits (ASIC), programmable logic device (PLD), other similar devices, or a combination thereof. The processing unit 120 detects whether the object has entered an initial sensing space 20 by analyzing the image captured by the image capturing unit 110, and establishes a virtual operating plane according to a location of the object when the object enters the initial sensing space 20 is detected, so as to detect a movement information of the object in the virtual operating plane 20.

The initial sensing space 20 is located at the first side faced by the display screen 24, and the initial sensing space 20 is located within an image capturing range of the image capturing unit 110. When using the input apparatus 11 for the first time, after the location of the input apparatus 11 and the facing direction (viz. the image capturing direction) of the image capturing unit 110, and the location of the input apparatus 11 are set, the processing unit 120 may establish the initial sensing space 20 in front of the display screen 24 according to a calibration information of the image capturing unit 110. Moreover, a background removal is executed on the initial sensing space 20. In terms of FIG. 2, the initial sensing space 20 has taken a desktop 23 as a reference, is established at a distance of about height D from the desktop 23. In other embodiments, it may also not require using the desktop 23 as the reference, and may directly define the initial sensing space according to the calibration information of the image capturing unit 110.

The calibration information, for example, may be pre-stored in a storage unit 150 of the input apparatus 11, or be manually set by a user. For instance, the user may enable the processing unit 120 to obtain images including a plurality of selected points through clicking a plurality of points (larger or equal to 4 points) that serves as an operational area, and define the appropriate initial sensing space 20 by taking these images as the calibration information.

The storage unit 150, for example, is any type of fixed or portable random access memory (RAM), read-only memory (ROM), flash memory, hard drive, or other similar device, or a combination thereof for recording a plurality of modules capable of being executed by the processing unit 120, thereby achieving a function of controlling the display screen.

The transmission unit 130, for example, is a wired transmission interface or a wireless transmission interface. For instance, the wired transmission interface may be an interface enabling the input apparatus 11 to connect to the Internet through an asymmetric digital subscriber line (ADSL), and the wireless transmission interface may be an interface enabling the input apparatus 11 to connect to one of a third generation telecommunication (3G) network, a wireless fidelity (Wi-Fi) network, a worldwide interoperability for microwave access (WiMAX) network, and a general packet radio service (GPRS) network, or a combination thereof. Moreover, the transmission unit 130 may also be a Bluetooth module, an infrared module, or so forth. The calculating device 130 has a corresponding transmission unit therein, so that the input apparatus 11 may mutually transmit the information to the calculating device 130 through the transmission unit 130.

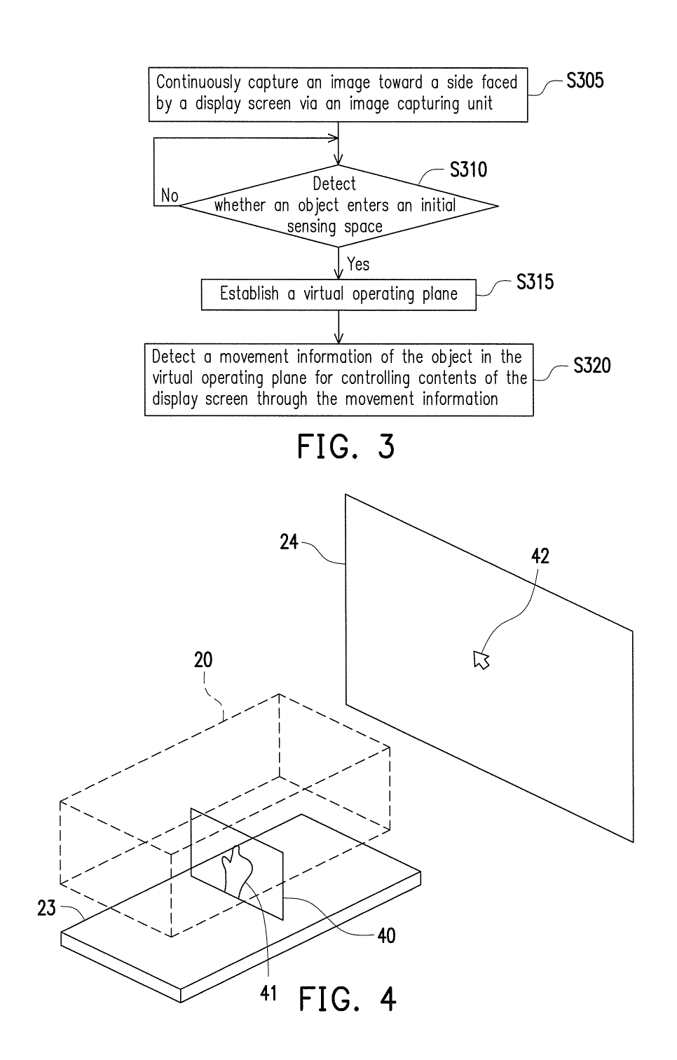

Detail steps of using the input apparatus 11 for controlling the display screen are provided in the descriptions of the following embodiment. FIG. 3 is a flow diagram illustrating a control method of a display screen according to an embodiment of the invention. Referring to FIG. 1 to FIG. 3 at the same time, in step S305, the image is continuously captured toward a side (the first side) faced by the display screen 24 via the image capturing unit 110. Next, the image analyzing process is executed by the processing unit 120 to the image captured by the image capturing unit 110. Herein, the image analyzing process includes steps S310 to S320.

In step S310, the processing unit 120 detects whether the object has entered the initial sensing space 20. The image capturing unit 110 continuously captures the image, and transmits the image to the processing unit 120 to determine whether the object is being entered. The processing unit 120, when detects that the object enters the initial sensing space 20, executes step S315, and establishes the virtual operating plane according to the location of the object. Herein, a size of the virtual operating plane is proportional to a size of the display screen of the display apparatus 13, and the virtual operating plane is substantially parallel to the display screen 20.

For instance, FIG. 4 is a schematic perspective diagram illustrating a control method of a display screen according to an embodiment of the invention. FIG. 4, for example, is the schematic perspective view of FIG. 2, with the initial sensing space 20 being presented above the desktop 23. The processing unit 120, after detecting an object 41 has entered the initial sensing space 20, establishes a virtual operating plane 40 substantially parallel to the display screen 24 according to the location of the object 41, and virtual operating plane 40 is proportional to the display screen 24 in size.

After the virtual operating plane 40 is established, in step S320, the processing unit 120 detects the movement information of the object 41 in the virtual operating plane 40 for controlling contents of the display screen 24 through the movement information. For instance, the input apparatus 11 transmits the movement information to the calculating device 12 through the transmission unit 130, and transforms the movement information of the virtual operating plane 40 into a movement information corresponded to the display screen 24 via the calculating device 12. Or, after the movement information of the virtual operating plane 40 is transformed by the processing unit 120 of the input apparatus 11 into the movement information corresponded to the display screen 24, the transmission unit 130 may transmit the transformed movement information to the calculating device 12.

In addition, after the virtual operating plane 40 is established, the calculating device 12 may further move a cursor 42 of the display screen 24 to the center of the display screen 24, as shown in FIG. 4. For instance, the processing unit 120, after establishing the virtual operating plane 40, may inform the calculating device 12 via the transmission unit 130, so that the calculating device 12 moves the cursor 42 to the center of the display screen 24. And, after the virtual operating plane 40 is established, the user may further execute various gesture operations in the virtual operating plane 40 using the object 41 (palm).

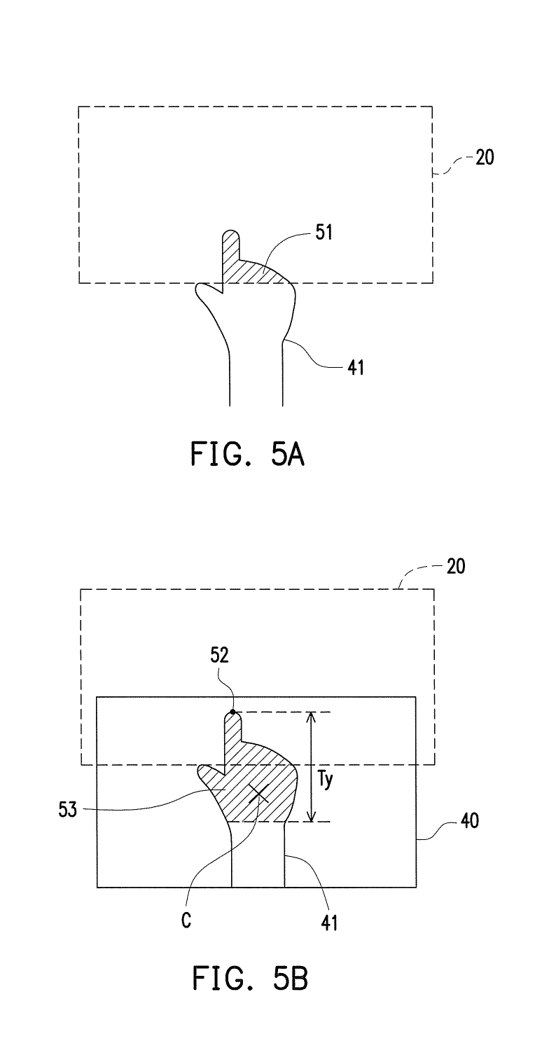

Detailed descriptions regarding the establishment of the virtual operating plane 40 are further provided in below. FIG. 5A and FIG. 5B are schematic diagrams illustrating an establishment of a virtual operating plane according to an embodiment of the invention.

Referring to FIG. 5A, when the processing unit 120 determines that the object 41 has entered the initial sensing space 20, a feature block 51 (a block illustrated with slashes in FIG. 5A) is further obtained based on the object 41 that has entered the initial sensing space 20. For instance, the processing unit 120 finds a feature block 51 using a blob detect algorithm.

After the feature block 51 is obtained, in order to avoid an erroneous determination, the processing unit 120 determines that whether an area of the feature block 51 is greater than a preset area. Under the area of the feature block 51 is determined as being greater than the preset area, the processing unit 120 determines that the user is to operate the display screen 24, and thereby concludes that the object 41 is to obtain the control of the display screen 24. If the area of the feature block 51 is smaller than the preset area, then it is determined that the user is not to operate e the display screen 24, and thereby ignores object 41 to avoid erroneous operation.

When the area of the feature block 51 is greater than the preset area, as shown in FIG. 5B, a boundary position 52 (such as an uppermost points above the feature block 51) of the feature block 51 is taken as a reference for determining a centroid calculation block 53 (the block illustrated with slashed in FIG. 5B) of the object 41 using a specified range Ty. The centroid calculation block 53 is a port of the object 41. In the present embodiment, by taking the boundary position 52 as the reference, the specified range Ty is obtained at below (base of the object 41), so as to determine the centroid calculation block 53. Afterward, the processing unit 120 calculates a centroid C of the centroid calculation block 53. Then, the processing unit 120 uses the centroid C as a center point to establish the virtual operating plane 40 by means of being proportional to the size of the display screen 24. Namely, the centroid C is the center point of the virtual operating plane 40. Herein, the size of the virtual operating plane 40 to the size of the display screen 24 is, for example, 1:5 in proportion.

After the processing unit 120 calculates the centroid C of the object 41, the image captured by the image capturing unit 110 is continued to be analyzed to obtain a movement information of the centroid C, and the movement information is transmitted to the calculating device 12 through the transmission unit 130, so that the calculating device 12 transforms a virtual coordinate of the centroid C in the virtual operating plane 40 into a display coordinate of the display screen 24. Moreover, the coordinate transformation may also be performed by the input apparatus 11. Namely, the processing unit 120 transforms the virtual coordinate of the centroid C in the virtual operating plane 40 into the display coordinate of the display screen 24, right after obtained the centroid C.

When the processing unit 120 detects that the object 41 leaves the virtual operating plane 40 for over a preset time (such as 2 second), the processing unit 120 releases the control of the object 41 and removes the setting of the virtual operating plane 40.

In the above embodiment, the virtual operating plane 40 is not completely located within the initial sensing space 20. In other embodiments, according to the user operation, the virtual operating plane 40 may also be completely located within the initial sensing space 20. Herein, the invention is not intended to limit the location of the virtual operating plane 40.

Moreover, if a plurality of objects enters the initial sensing space 20 is detected at the same time, the control to be obtained by the objects may be determined according to a distance between the display screen 24 and each respective object. The following below provides another embodiment with detailed descriptions.

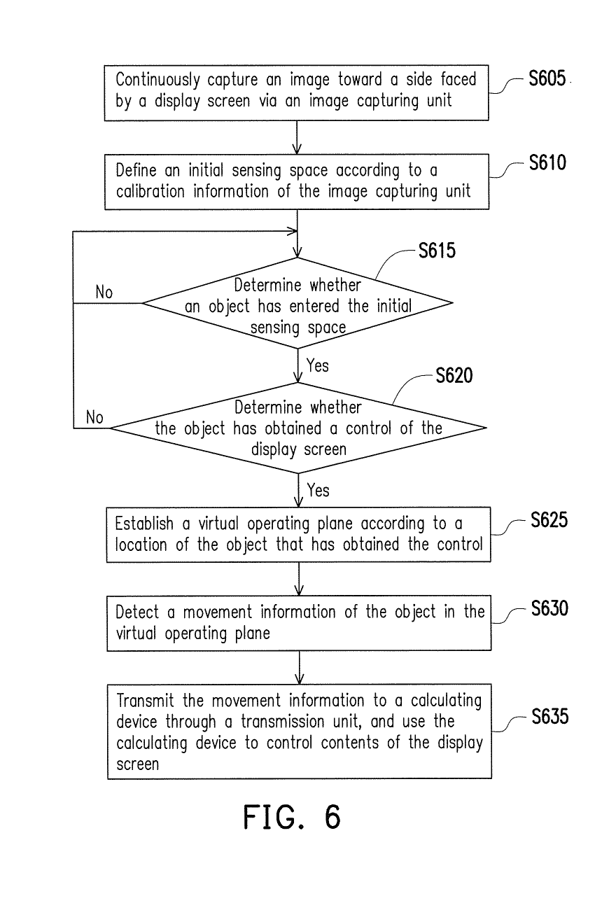

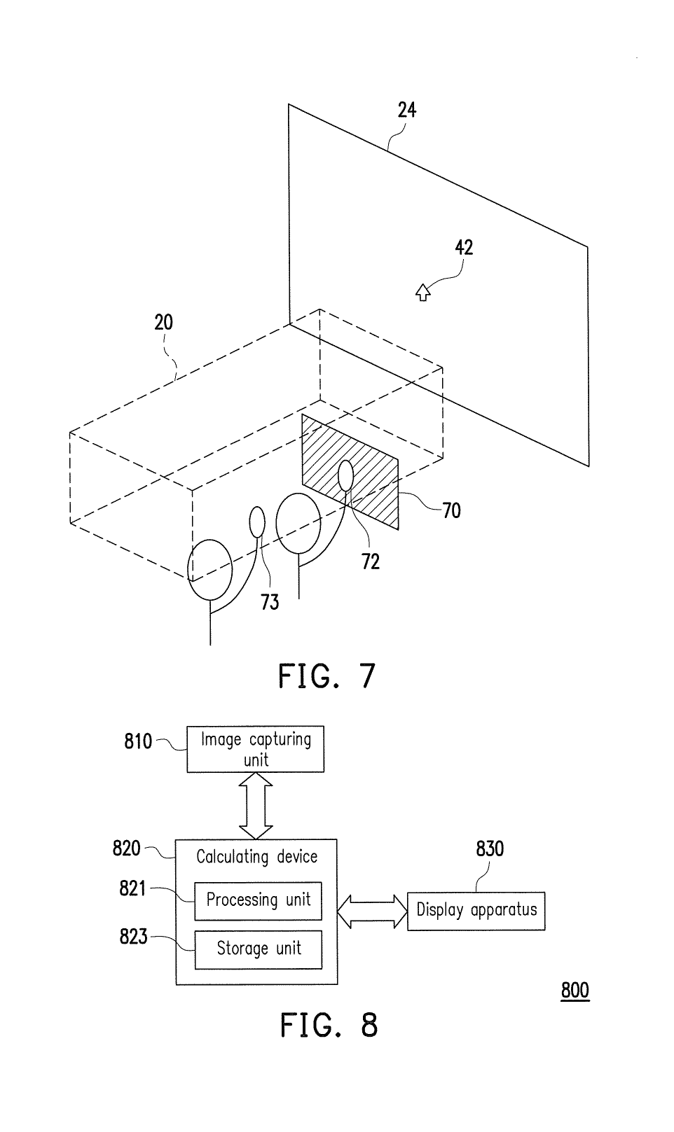

FIG. 6 is a flow diagram illustrating a control method of a display screen according to another embodiment of the invention. FIG. 7 a schematic perspective diagram illustrating a control method of a display screen according to another embodiment of the invention. Detailed descriptions of the embodiment, accompanied by FIG. 1 and FIG. 2, are provided in the following below.

In step S605, the image is continuously captured by the image capturing unit 110 toward a side (the first side) of the display screen 24. The processing unit 120 executes the image analyzing process to the image captured by the image capturing unit 110. Herein, the image analyzing process includes steps S610 to S630.

Next, in step S610, the processing unit 120 defines the initial sensing space 20 according to the calibration information of the image capturing unit 110, and executes the background removal to the initial sensing space 20. After the initial sensing space 20 is defined, the image capturing unit 110 continuously captures the image and transmits the image to the processing unit 120, so that the processing unit 120 detects whether the object has entered the initial sensing space, as shown in step S615.

Herein, in terms of FIG. 7, by assuming that the processing unit 120 detects an object 72 and an object 73 entering the initial sensing space 20, and by assuming that areas of feature blocks of the object 72 and the object 73 are also greater than the preset area, the processing unit 120 further calculates respective distance from the object 72 and the object 73 to the display screen 24, so as to determine that the one (viz., the object 72) being closest to the display screen 24 in distance is to obtain the control of the display screen 24.

Afterward, in step S625, the processing unit 120 establishes a virtual operating plane 70 according to a location of the object 72 that has obtained the control. Herein, the descriptions of the establishment of the virtual operating plane 70 may be referred to FIG. 5A and FIG. 5B, and thus are not to be repeated. Moreover, after the virtual operating plane 70 is established, the input apparatus 11 informs the calculating device 12 to enable the calculating device 12 to move the cursor 42 of the display screen 24 to the center thereof.

Then, in step S630, the processing unit 120 detects a movement information of the object 72 in the virtual operating plane 70. For instance, the processing unit 120 is continued to detect a movement information of a centroid of the object 72, so that the cursor 42 may correspondingly be controlled based on a coordinate location of the centroid.

Finally, in step S635, the movement information is transmitted to the calculating device 12 through the transmission unit 130, and the contents of the display screen 24 is controlled by the calculating device 12. By according to the calculating device 12 or using the input apparatus 11 to perform a coordinate transformation, the aforementioned movement information may be a coordinate information of the virtual operating plane 70, or may also be a coordinate information of the display screen 24 after the transformation. In addition, when the processing unit 120 detects that the object 72 leaves the virtual operating plane 70 over a preset time (such as 2 seconds), the processing unit 120 release the control of the object 72 and removes the setting of the virtual operating plane 70.

In other embodiments, no additional independent input apparatus 11 is required to be disposed, such that the calculating device 12 may directly be used to analyze the image of the image capturing unit 110. Detailed descriptions of another embodiment are further provided in below.

FIG. 8 is a block diagram illustrating a control system for a display screen according to another embodiment of the invention. Referring to FIG. 8, a control system 800 includes an image capturing unit 810, a calculating device 820 and a display apparatus 830. The present embodiment analyzes an image captured by the image capturing unit 810 through the calculating device 820, and then controls contents displayed by the display apparatus 830 according to an analysis result.

In FIG. 8, functions of the image capturing unit 810 are similar to that of the of the image capturing unit 110. The display apparatus 830 may be any type of display. The calculating device 820, for example, is a desktop computer, laptop computer, tablet PC. The calculating device 820 includes a processing unit 821 and a storage unit 823. The calculating device 820 uses wired or wireless means to couple to the display apparatus 830, so as to display the desired contents through the display apparatus 830. In addition, the calculating device 820 has the ability to control the display contents. In the present embodiment, the processing unit 120 may execute a plurality of modules (for achieving the function of controlling the display screen) record in a storage unit 823 of the calculating device 820. The image capturing unit 810 is responsible for continuously capturing an image toward a first side faced by the display screen 24, and uses the wired or wireless manner to transmit the captured image to the calculating device 820. The processing unit 821 of the calculating device 820 executes an image analyzing process to the image for controlling the contents of the display screen of the display apparatus 830. Accordingly, in the present embodiment, no additional independent input apparatus 11 is required to be disposed. Detailed descriptions regarding to the image analyzing process executed by the processing unit 821 may be referred to the steps S310 to S320 or the steps S610 to S630 in above, and thus are omitted herein.

In summary, in the above-mentioned embodiments, it is to firstly decide whether an object in the initial sensing space has obtained the control of the display screen, and then to establish the virtual operating plane according to the location of the object, so as to control the contents of the display screen according to the movement information of the object in the virtual operating plane. As such, through the initial sensing space, a situation of having erroneous operation may be avoided. And, the virtual operating plane being substantially parallel to the display screen is established in the manner of being proportional to the display screen in size, and thus may provide an intuitive operation. Moreover, if there is a plurality of objects being entered into the initial sensing space, then after the priority in obtaining the control has been determined among these objects, the virtual operating plane may be established according to the location of the object that has obtained the control. As such, through the abovementioned embodiments, the contents of the display screen may be controlled in the three-dimensional space under the condition of not limiting the amount of user or object.

It will be apparent to those skills in the art that various modifications and variations can be made to the structure of the present invention without departing from to the scope or spirit of the invention. In view of the foregoing, it is intended that the present invention cover modifications and variations of this invention provided they fall within the scope of the following claims and their equivalents.

What is claimed is:

1. A control method of a display screen, comprising:
continuously capturing an image toward a first side faced by a display screen of a display apparatus through an image capturing unit; and
executing an image analyzing process for the image captured by the image capturing unit via a processing unit, wherein the image analyzing process comprises:
detecting whether an object has entered an initial sensing space, wherein the initial sensing space is located at the first side, and the initial sensing space is located within an image capturing range of the image capturing unit;
establishing a virtual operating plane according to a location of the object when the object enters the initial sensing space is detected, wherein a size of the virtual operating plane is proportioned to a size of the display screen; and
detecting a movement information of the object in the virtual operating plane for controlling contents of the display screen through the movement information.

2. The control method as recited in claim 1, wherein, before the step of establishing the virtual operating plane according to the location of the object when the object enters the initial sensing space is detected, further comprises:
determining whether the object is to obtain a control of the display screen, comprising:
obtaining a feature block based on the object entered the initial sensing space;
determining whether an area of the feature block is greater than a preset area; and
determining that the object is to obtain the control of the display screen if the area of the feature block is greater than the preset area.

3. The control method as recited in claim 2, wherein the step of establishing the virtual operating plane according to the location of the object comprises:
using a boundary position of the feature block as a reference, and using a specified range to determine a centroid calculation block of the object;
calculating a centroid of the centroid calculation block; and
establishing the virtual operating plane by using the centroid as a center point, and by being proportional to the size of the display screen.

4. The control method as recited in claim 3, wherein after the step of detecting the movement information of the object in the virtual operating plane, further comprises:
transmitting the movement information to a calculation device of the display apparatus, and transforming a virtual coordinate of the centroid in the virtual operating plane into a display coordinate corresponded to the display screen through the calculating device.

5. The control method as recited in claim 3, wherein after the step of detecting the movement information of the object in the virtual operating plane, further comprises:
transforming a virtual coordinate of the centroid in the virtual operating plane into a display coordinate corresponded to the display screen.

6. The control method as recited in claim 2, wherein the step of determining whether the object is to obtain the control of the display screen further comprising:
calculating distances from the object and from another object to the display screen, respectively, when the another object has simultaneously entered the initial sensing space and when an area of the feature block of the another object is also greater than the area of the preset area, so that the one being closest to the display screen in distance is determined to obtain the control of the display screen.

7. The control method as recited in claim 1, wherein after the step of establishing the virtual operating plane, further comprises:
moving a cursor of the display screen to the center of the display screen.

8. The control method as recited in claim 1, wherein after the step of establishing the virtual operating plane, further comprises:
release the control of the object when the object leaves the virtual operating plane over a preset time, so as to remove a setting of the virtual operating plane.

9. The control method as recited in claim 1, further comprising:
defining the initial sensing space according to a calibration information of the image capturing unit; and
executing a background removal to the initial sensing space.

10. An input apparatus, comprising:
an image capturing unit continuously capturing an image toward a first side faced by a display screen of a display apparatus;
a processing unit coupled to the image capturing unit, detecting whether an object has entered an initial sensing space by analyzing the image captured by the image capturing unit, and establishing a virtual operating plane according to a location of the object when the object enters the initial sensing space is detected, so as to detect a movement information of the object in the virtual operating plane, wherein the initial sensing space is located at the first side, the initial sensing space is located within an image capturing range of the image capturing unit, a size of the virtual operating plane is proportioned to a size of the display screen, and the virtual operating plane is parallel to the display screen; and
a transmission unit coupled to the processing unit, configured to transmit the movement information to a calculating device corresponded by the display apparatus for controlling contents of the display screen.

11. The input apparatus as recited in claim 10, wherein the processing unit obtains a feature block based on the object entered the initial sensing space, and determines that the object is to obtain a control of the display screen when an area of the feature block is greater than a preset area.

12. The input apparatus as recited in claim 11, wherein the processing unit uses a boundary position of the feature block as a reference and uses a specified range, to determine a centroid calculation block of the object, and calculates a centroid of the centroid calculation block, so as to establish the virtual operating plane by using the centroid as a center point, and by being proportional to the size of the display screen.

13. The input apparatus as recited in claim 12, wherein the processing unit transforms a virtual coordinate of the centroid in the virtual operating plane into a display coordinate corresponded to the display screen, and the transmission unit transmits the display coordinate to the calculating device.

14. The input apparatus as recited in claim 12, wherein the transmission unit transmits a virtual coordinate of the centroid in the virtual operating plane to the calculating device.

15. The input apparatus as recited in claim 11, wherein the processing unit calculates distances from the object and from another object to the display screen, respectively, when simultaneously detects that the object has entered the initial sensing space, and a the another object has also entered the initial sensing space, and when an area of the respective features block of the object and the another object is greater than the preset area, so as to determine that the one being closest to the display screen in distance is to obtain the control of the display screen.

16. The input apparatus as recited in claim 10, wherein the processing unit releases the control of the object when detects that the object leaves the virtual operating plane over a preset time, and removes a setting of the virtual operating plane.

17. A control system for a display screen, comprising:
a display apparatus displaying a display screen;
a calculating device coupled to the display apparatus for controlling content of the display screen; and
an input apparatus coupled to the calculating device and comprises:
an image capturing unit continuously capturing an image toward a first side faced by the display screen of the display apparatus;
a processing unit coupled to the image capturing unit, detecting whether an object has entered an initial sensing space by analyzing the image captured by the image capturing unit, and establishing a virtual operating plane according to a location of the object when the object enters the initial sensing space is detected, so as to detect a movement information of the object in the virtual operating plane, wherein the initial sensing space is located at the first side, the initial sensing space is located within an image capturing range of the image capturing unit, a size of the virtual operating plane is proportioned to a size of the display screen, and the virtual operating plane is parallel to the display screen; and
a transmission unit coupled to the processing unit, and configured to transmit the movement information to the calculating device so that the calculating device controls contents of the display screen according to the movement information.

18. A control system for a display screen, comprising:
a display apparatus displaying a display screen;
an image capturing unit continuously capturing an image toward a first side faced by the display screen; and
a calculating device coupled to the image capturing unit and the display apparatus, detecting whether an object has entered an initial sensing space by analyzing the image captured by the image capturing unit, and establishing a virtual operating plane according to a location of the object when the object enters the initial sensing space is detected, so as to detect a movement information of the object in the virtual operating plane for controlling the content of the display screen through the movement information;
wherein, the initial sensing space is located at the first side, the initial sensing space is located within an image capturing range of the image capturing unit, a size of the virtual operating plane is proportioned to a size of the display screen, and the virtual operating plane is parallel to the display screen.
